(19) United States
(12) Patent Application Publication
(10) Pub. No.: US 2001/0049620 A1
(43) Pub. Date: Dec. 6, 2001

(54) Privacy-protected targeting system

(76) Inventor: John P. Blasko, New Hope, PA (US)

Correspondence Address: Douglas J. Ryder, Expanse Networks, Inc., 300 North Broad Street, Doylestown, PA, 18901, US

(21) Appl. No.: 09/796,339

(22) Filed: Feb. 28, 2001

Related U.S. Application Data
(60) Provisional application No. 60/185,789, filed on Feb. 29, 2000.
(60) Provisional application No. 60/190,341, filed on Mar. 16, 2000.

(51) Int. Cl. G06F 17/60

(52) U.S. Cl. 705/10; 705/14

(57) ABSTRACT

A system and method for transaction profiling in a privacy-protected manner, wherein the transaction generally refers to an intentional action by a user. For example, in the context of television programming, the transaction data may relate to programming and advertisements watched by the user over a predetermined period of time. A transaction profile vector based on the evaluation of the recorded transaction data is then computed, wherein the transaction profile vector may include demographic attributes such as probable age, household size, income level of the user, or preference attributes indicating probable products and services preferred by the user. To protect privacy, the generation of the transaction profile vector (also known as profile vector) preferably takes place local to the transaction.

This application claims priority under 35 USC 1.19(e) of provisional application Nos. 60/185,789 filed on Feb. 29, 2000 and 60/190,341 filed on Mar. 16, 2000. These applications are hereby incorporated by reference in their entirety.

### BACKGROUND OF THE INVENTION

In advertising and marketing, it is considered highly desirable to target advertisements to the appropriate potential customer base, rather than to broadcast advertisements in general. For example, it has been long known that advertisements for computers should not appear in magazines on gardening and, conversely, advertisements for gardening tools should not appear in magazines on computers.

Prior to the widespread use of the Internet, most targeted advertising was accomplished through mail or by telephone directed to the potential customer. The recent development of on-line networks, such as the Internet, has led to “on-line” advertising. For example, often on-line advertisements on the Internet appear on a web page as a banner advertisement located on the top or bottom of the web page. Also, advertising messages have been targeted using electronic mail (e-mail).

Many vendors have developed techniques for targeting advertisements over the Internet. In one technique, information about networks and subnetworks is routinely collected. In addition, information about individual users is also gathered and stored on network servers when the user selects (clicks on) different advertisements. Also, data is tracked on how often a given advertisement has been displayed, how often a given user has seen a given advertisement, and other information regarding the user. Based on the collected information, the user is presented with targeted advertisements.

Another set of targeted advertisement schemes has been developed by utilizing point-of-sale data. These types of schemes are generally used in retail stores, wherein the sales transactions are recorded and coupons are generated and distributed in retail stores based on the products purchased by the consumers. This scheme generally involves evaluating the purchase record and identifying an additional item associated with one or more purchased items and then offering an advertisement or a discount coupon for the additional item. Generally, the additional item is a competitive item or a complementary item.

Targeted advertising has also made its presence in broadcast television environments. In particular, some attempts have been made to match the television advertisements to users. One scheme is based on the use of commonly known geography-based databases. These databases are generally based on psychographic analysis that attempts to segment consumer lifestyles into identifiable characteristics. One of the first systems for this type of profiling was done in 1978 by SRI and is known as VALS (Values and Lifestyle). Essentially, in the lifestyle segmentation system, the database is correlating the geography (e.g., zip code) vs. predetermined empirical demographic profiles (e.g., household income, age, etc.)

In one example, each geographic datapoint, such as street address and radius, provides a distribution of households that are in each of the predetermined profile definitions. In other words, every household is slotted into one of several predefined profile clusters. Based on further empirical studies, the likely preferences and interests of a cluster member is determined. However, these databases lack information on specific individual user behavior, e.g., preferences, likes, demographics, etc.

A new practice of profiling, more commonly referred to as user (“consumer”) profiling, has been also introduced in the market. This practice involves gathering information about an individual and, from the data collected, making assertions about the nature of that individual. Typically marketing firms do this in order to target advertisements and promotional materials to those individuals that would have a higher likelihood of having interest in receiving particular materials. Data about an individual can be gathered from numerous sources. The sources include catalog purchases, television-viewing habits, purchases made under a retail club membership card (such as those found at many grocery stores), as well as Internet surfing activities.

Generally, data tracking schemes relating to individual user behavior are very intrusive, and have lately come under fire by one or more privacy advocacy groups. The user behavior to be tracked may comprise point-of-sale transactions, Internet surfing behaviors, product registration transactions, etc. In these data tracking schemes, personal information about the user is collected, e.g., in an Internet environment, generally an advertisement server monitors each web page visited by the user and creates a cumulative record of these visits. Many users are not aware that such information is being collected about them, and become upset when such data collecting techniques are discovered.

In the Internet environment, some solutions have been proposed to eradicate the privacy invading effects of the data tracking schemes. Most of the popular Web browsers or Internet browsers have limited capabilities to filter the cookies. At least two filters have been sanctioned by the World Wide Web Consortium (W3C) in its standards, which include a “same domain” filter, and a manual filter based on prompts. Generally, the W3C-compliant browsers have only an on mode or an off mode. For example, if the browser makes a Hypertext Transfer Protocol (HTTP) request to a particular domain, e.g., domain.com, via a browser-based filter, the browser will only let domain.com put a cookie on the hard drive in the cookie.txt file, but it will not allow, in retrieving that same page, any other secondary domain place cookies on the hard drive.

However, tracking companies have circumvented this filtering method by setting up third level domain names that have the same base second level domain name, e.g., ad.domain.com. Also, the cookies may be manually filtered on an individual basis. This mechanism is cumbersome and unduly interrupts the user's browser session. These filtering limitations are problematic, since cookies have a useful legitimate purpose when employed for personalization rather than tracking purposes.

In the Internet environment, many different types of software tools are also available, e.g., Symantec's Norton Internet Security 2000™. This software tool has a built-in filter that can selectively block the cookies, or even erase the pre-existing cookies. There is a similar product, namely Internet Junk Busters™, a free downloadable software that permits more than one type of filtering, including blocking cookies.

Another known solution is based on the concept of anonymizing. In this solution, the user goes to a particular Web-site via a secure link, and subsequent HTTP requests to other URL sites are transmitted via this site. The anonymizing software at the secure Web-site makes all the outgoing requests anonymous because all the users are provided with the same primary IP address. Thus, the solution makes the user anonymous because multiple users are shown to utilize one IP address. This solution is similar to the Norton Internet Security 2000™ and the Internet Junk Busters™ because it is a proxy. This proxy is generally bi-directional, e.g., it filters the information going upstream to the Web as well as the downstream information received from the Web.

However, the above-mentioned privacy protection schemes are specific to Internet environments, and generally are not applicable to television environments which comprise the most promising emerging markets in the area of targeted advertising. These schemes also create a new problem by interfering with the browsing session, since Web-sites will generally block access to users who do not permit the cookie to deposited in the user's cookie.txt file.

Thus, there exists a need for novel profiling schemes for television environments which protect the privacy of the consumer.

### SUMMARY OF THE INVENTION

The present invention overcomes the limitation of the prior art by providing a system and method for transaction profiling in a privacy-protected manner, wherein the transaction generally refers to an intentional action by a user. For example, in the context of retail stores, this transaction may relate to a purchase record, i.e., a list of purchases made by the user. In the context of the Internet, this transaction data may be an Internet purchase or viewing of one or more web pages. In the context of television programming, the transaction data may relate to programming and advertisements watched by the user over a pre-determined period of time. The principles of the present invention are flexible and may operate with one or more definitions of the transactions and corresponding transaction data.

A transaction profile vector based on the evaluation of the transaction data is computed, wherein the transaction profile vector may include demographic attributes such as probable age, household size, income level of the user, or preference attributes indicating probable interests, video programs, products and services preferred by the user. To protect privacy, the generation of the transaction profile vector (also known as profile vector) preferably takes place local to the transaction. For example, in the Internet environment, the profile vector may be generated on the client side at a browser or on the server side at a local server. In a retail environment, the profile vector may be generated at a point-of-purchase register or at a local store server. In a television environment, the profile vector may be generated at a television, pcTV, set-top box (STB), video cassette recorder (VCR), head-end location or the like. In a switched digital video (SDV) environment, the profile vector may be generated at a television, pcTV, STB, premises gateway, broadband digital terminal (BDT), or the like.

In its most basic form, the profile vector may be comprised of the raw transaction data. However, a processed profile vector may be generated locally by using embedded or download software or a combination thereof. The profiling software may reside in an application specific integrated circuit in the local appliance or the software may be loaded into a general purpose processor for the purposes of collecting and processing profiling data. It should be noted that the profile vector generation is a dynamic process, and the updated software or auxiliary data such as heuristic rules may be included in the process of profile vector generation.

The principles of the present invention are flexible and one or more heuristic rules may be used to create various transaction profile vectors. These heuristic rules may be expressed in logic form which allows the use of generalizations which have been obtained from external studies. These generalizations assist in a characterization of the transaction data to generate a profile vector. The heuristic rules may also be expressed as conditional probabilities, i.e., determination of the transaction data is applied statistically to obtain probabilistic profile vectors. These probabilistic profile vectors may include demographic attributes indicating probable age, income level, gender, and other demographics.

The generated transaction profile vector is assigned a transaction identification (ID). This transaction ID may simply comprise a random attribute such as an arbitrary number or value. Preferably, this number or value is selected not to reflect any personal information about the user and instead is a random and arbitrary number, e.g. the transaction ID may be based on the time and date of purchase, the number of sales made that day. Alternatively, this transaction ID may be the identifier for the server generating the profile vector. In the television environment, the transaction ID may be a MAC_ID for the STB.

After the profile vector has been assigned a transaction ID, the profile vector having a transaction ID is evaluated for the purposes of selecting a suitable targeted advertisement to be presented to the user. This evaluation may be based on a plurality of factors, e.g., the current profile vector having a transaction ID may be compared against previously stored profile vectors to select a suitable targeted advertisement using collaborative filtering techniques. Alternatively, the targeted advertisement may be based solely on information contained in the current profile vector. In instances where more than one transaction from the same user are observed and analyzed, the profile vectors are assigned a profile ID, stored in a storage medium, and indexed by the profile ID. It is to be noted that the profile ID is usually a random or arbitrary number selected carefully to guard user privacy.

In one embodiment, a secured correlation system is developed by the use of a secure correlation server. The secure correlation server receives one or more locally generated profile vectors, and in return generates aggregated profile vectors that may be utilized to match a suitable targeted advertisement or offer to the user. Herein, the profile vectors are based on the individual patterns of preferences and behavior, whereby the targeted advertisements are selected by matching patterns to similar patterns of other users. The advantages of using individualized profile vectors include the ability to select targeted advertisements reflecting a better probabilistic measurement of user likes/dislikes. Thus, the user is not flooded with junk, useless information, offers or advertisements that are of no interest to them, instead the advertisements are selected to better fit the needs and the preferences of the user. It is anticipated that the targeted advertisements are far likely to succeed with the user than traditional advertising. Thus, this embodiment offers advantages for both the user as well as the advertiser/retailer. The user is receiving what he prefers and the advertiser has a higher success rate, while user privacy has been secured.

In one embodiment of the present invention, a computer-implemented method for presenting one or more targeted advertisements to a user is disclosed. The method includes monitoring user behavior for one or more intentional actions to collect transaction related data and then processing the transaction related data in order to generate one or more user profile vectors.

In another embodiment of the present invention, a computer system for presenting one or more targeted advertisements to one or more users in a privacy protected manner is disclosed. The computer system includes a plurality of remote databases storing transaction profile information relating to one or more user transactions. A plurality of local profilers coupled to the remote databases for processing the transactional information and generating one or more enhanced profile vectors. A secure profiling server coupled to the local profilers, receives and processes one or more of the locally generated profile vectors.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a block diagram of different steps involved in a process in accordance with the embodiment of the present invention;

FIG. 2 illustrates various steps involved in the processing of selection and presentation of one or more advertisements;

FIG. 3 illustrates an exemplary case of a generalized transaction profile vector according to the present invention;

FIG. 4 illustrates a secure correlation server configured to receive transaction profile vectors from one or more sources;

FIG. 5 illustrates an implementation of the present invention in web browsing environments;

FIG. 6 illustrates an exemplary implementation for a television environment wherein a set-top box comprises a profile engine connected to one or more profile filters;

FIG. 7 illustrates an exemplary case wherein an evaluator receives an actual profile vector from a local profiler;

FIG. 8 illustrates an exemplary implementation of the profile exchange subsystem of the present invention;

FIG. 9 illustrates a secure profiling server configured to receive a plurality of locally generated profiling vectors from a plurality of sources;

FIG. 10 illustrates an exemplary system based on the principles of the present invention; and

FIG. 11A illustrates advertisement applicability modeled as a distribution curve;

FIG. 11B illustrates an exemplary case of targeted marketing, where subscribers are divided into subgroups and the advertisement is displayed only to a subgroup of the subscribers; and

FIG. 11C illustrates an exemplary case where different success rates are determined by measuring products or services that were purchased as the result of the viewing of a targeted advertisement.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

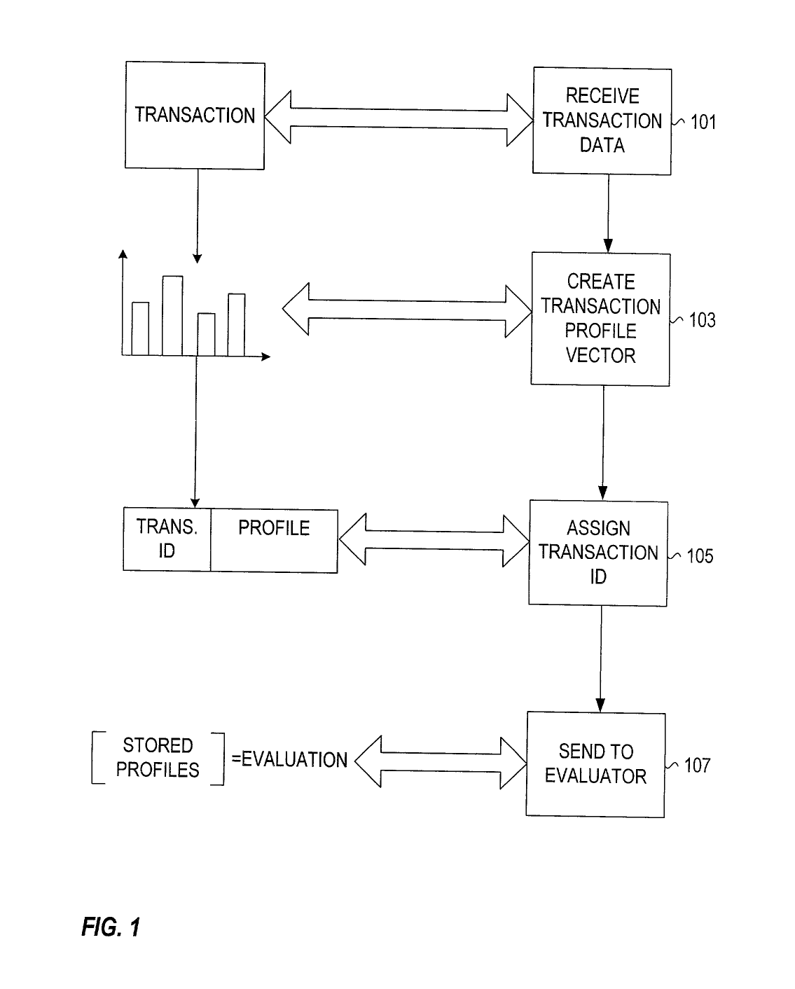

With reference to the drawings, in general, and FIGS. 1 through 11C, in particular, the apparatus of the present invention is disclosed.

FIG. 1 illustrates a block diagram of different steps involved in a process in accordance with an embodiment of the present invention. The process starts in step 101 by receiving transaction related data. This transaction related data generally refers to an action by a user. For example, in the context of retail stores, this transaction data may be a purchase record, i.e., a list of purchases made by the user. In the context of the Internet, this transaction data may be an Internet purchase or viewing of one or more web pages. In the context of television programming, the transaction data may relate to programming and advertisements watched by the user over a predetermined period of time. The principles of the present invention are flexible and may operate with one or more definitions of the transactions and corresponding transaction data.

Next, in step 103, a transaction profile vector is created based on the evaluation of the recorded transaction data. To protect privacy, the generation of the transaction profile vector (also known as profile vector) preferably takes place local to the transaction. For example, in the Internet environment, the profile vector may be generated on the client side at a browser or on the server side at a local server. In a retail environment, the profile vector may be generated at a point-of-purchase register or a local store server. In a television environment, the profile vector may be generated at a television, pcTV, set-top box (STB), video cassette recorder (VCR), personal video recorder (PVR), television distribution head-end location or the like. In a switched digital video (SDV) environment, the profile vector may be generated at a television, pcTV, STB, premises gateway, broadband digital terminal (BDT), central switching office (CO) or the like.

Generally, any networked appliance where a series of actions may be measured or recorded is a candidate for a profile vector generator, according to the present invention. Of course, raw transaction data may be transmitted to a remote secure server, including an evaluator server or a secure correlation server, for the purpose of generating the profile vector. However, it is preferable to generate the profile vector locally in order to distribute the processing requirements (and therefore allow faster central processing for evaluation) and to preserve the privacy of the transaction. If the raw transaction data is transmitted to the evaluator or a secure correlation server for processing, there is an increased risk that the data will not be discarded after the profile vector is generated.

For example, in generating a transaction profile vector from a television viewing session, the information about channel selection and the viewing duration may be available only locally at the television or STB. To generate a profile vector based on the viewer's preferences, it may be necessary to extract programming information from other sources such as an electronic program guide (EPG), closed caption text or to download the programming information and synchronize it with the recorded channel selection, duration, etc. Set-top box profile generation may be carried out according to the methods and systems disclosed in U.S. provisional patent application Nos. 60/260,946 filed Jan. 11, 2001 entitled “Viewer Profiling with a Set-top Box” and 60/263,095 filed Jan. 19, 2001 entitled “Session Based Profiling in a Television Environment,” both applications being hereby incorporated by reference in their entirety.

In its most basic form, the profile vector may be comprised of the raw transaction data. However, a processed profile vector may be generated locally by using embedded or download software or a combination thereof. The profiling software may reside in an application specific integrated circuit in the local appliance or the software may be loaded into a general purpose processor for the purposes of collecting and processing profiling data. It is to be noted that the profile vector generation is a dynamic process, and the updated software or auxiliary data such as heuristic rules may be included in the process of profile vector generation.

The principles of the present invention are flexible and one or more heuristic rules may be used to create various transaction profile vectors. These heuristic rules may be expressed in logic form which allow the use of generalizations been obtained from external studies. These generalizations assist in the characterization of the transaction data to generate a profile vector. The heuristic rules may also be expressed as conditional probabilities, i.e., determination of the transaction data is applied statistically to obtain probabilistic profile vectors. These probabilistic profile vectors may include demographic attributes indicating probable age, income level, gender, and other demographics.

Also, heuristic rules for determining such demographic attributes such as probable gender or age may evolve over time or may be developed externally and thus have to be downloaded to the profile vector generator from time to time. Thus clusters of viewing profiles or signatures, for example, may be generated from which gender or age may be determined. These signatures can be downloaded to the profile generator for comparison to the current viewing profile and gender or age of the viewer can be determined or inferred.

Also, it is anticipated that the formats and attributes of different types of profile vectors will not be rigid and will have to be updated periodically. The actual profile vector generation may involve creating a probabilistic profile vector for the user or simply recording and compiling preferences. The profile vectors may also be based on user preference attributes such as product likes or dislikes, brand name loyalties or viewing preferences.

In the case of television programming, the profile vectors may also indicate the type of programming the user is interested in. In the case of the Internet, the profile vectors may indicate the type and style of web pages the user prefers or the interests of the user based on the content of the web pages.

It is to be noted, in the present invention after the transaction data has been processed to create a profile vector, the raw transaction data is discarded. This protects user's privacy. Also, unlike prior art where the user's private information is collected (generally in an unauthorized and objectionable manner), in the present invention, the user identification is not even a requirement. The user is a black-box figure and may exist in a virtual world. The user is not required to disclose any personal information and if any personal information, e.g., name, m-mail ID, credit card information, is available, this information is discarded along with other transaction data. Furthermore, unlike prior art, the user's private information is not sold/made available to third parties. The principles of the present invention specifically include means for guarding user privacy.

In step 105, the recently generated current profile vector is assigned a transaction ID. This transaction ID may simply comprise a random attribute such as an arbitrary number or value. Preferably, this number or value is selected not to reflect any personally identifiable information about the user and instead is a random and arbitrary number, e.g. the transaction ID may be based on the time and date of purchase, the number of sales made that day. Alternatively, the transaction ID may be the identifier for the server generating the profile vector. In the television environment, the transaction ID may be a MAC_ID for the STB.

After the profile vector has been assigned a transaction ID, the profile vector having a transaction ID is transmitted to an evaluator (step 107) for further evaluation and generation of targeted advertisements. This evaluation may be based on a plurality of factors, e.g., the current profile vector having a transaction ID may be compared against previously stored profile vectors to determine a suitable targeted advertisement using, for example, collaborative filtering techniques. Alternatively, the targeted advertisement may be based solely on the current profile vector. It is to be noted that in instances where more than one transaction from the same user are observed and analyzed, the profile vectors are assigned a profile ID and are stored in a storage medium with the profile ID. It is to be noted that the profile ID is usually a random or arbitrary number selected carefully to guard user privacy.

Note that steps 101-107 are preferably performed in real-time, i.e., the user transaction data is obtained/processed within a few milliseconds and the user is instantly presented with the advertisement. Preferably, there is no delay of latency in the presentation of the advertisement.

Furthermore, in the retail environment, the transaction data, which may be a point-of-sale purchase data is evaluated to determine a profile vector and a probabilistic indicator of user likes and preferences. Thus, the advertisements have a wide range, and thereby a greater likelihood of success. Unlike prior art, the advertisements are not based merely on comparison and elections of competitor's products and instead are based on user characterization and profiling.

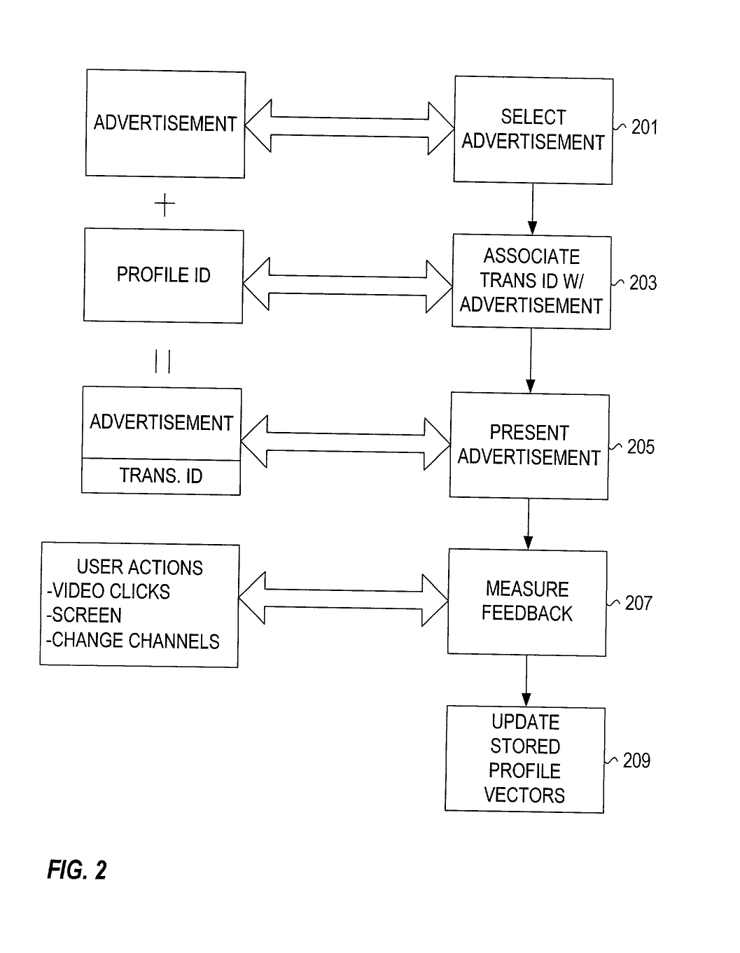

FIG. 2 illustrates various steps involved in the processing of the selection and presentation of one or more advertisement. The processing starts in step 201 by the selection of a suitable targeted advertisement. As described above, this selection may be based on the current profile vector, or it may be based on the current profile vector as well as on the comparison of the current profile vector to one or more stored profile vectors.

The advertisements may also be selected based on attributes corresponding to the advertisement criteria that the profiled recipient is likely to view favorably. The advertisement attributes are compared to the available pool of advertisements to determine which advertisement most closely matches the ideal advertisement criteria of the profile. The advertisement may have attributes such as style of advertisement, e.g., humorous, informative, etc; type of goods/services offered, e.g., food, hardware, office supplies, etc.; gender, i.e., male or female; and the like. Thus selections may be made from different styles of advertisements for the same product, a selection of different products and services, or a combination thereof. In another embodiment, advertisement attributes may be submitted to a secure correlation server which returns either an ideal customer profile (based on the evaluation of one or more available profile vectors), a series of profiles of customers who would be receptive to the advertisement, or secure identification values for individual customers who would be receptive to the advertisement, e.g., street addresses, names, set-top box MAC_ID, etc.

After a suitable targeted advertisement has been selected, the next step 203 is to associate the transaction ID with the advertisement. This transaction ID may be the same ID which corresponds to the current transaction profile vector. The transaction ID may be later used to associate the advertisement with the profile vector, as well as to determine the success rates of the presented advertisements.

In step 205, the selected advertisement is presented to the user. This advertisement may be presented in different ways, e.g., in the retail store environments, the advertisement may be presented as a coupon/gift certificate along with the printed receipt. In the Internet environment, the advertisement may be presented as a banner advertisement on a web page. In television programming, the advertisement may be presented as a substitution of a locally inserted advertisement over a broadcast network advertisement.

In step 207, feedback on the presented advertisement is measured. In the Internet environment, such measurements can be made by monitoring the user's clicks on different web-pages. In the television programming, these measurements can be made by monitoring the user's viewing habits, e.g. how much, if any portion of the displayed advertisement was watched by the user. The user's viewing habits are generally monitored by observing channel change commands or volume change commands initiated by the user.

The user feedback may be obtained by observing whether the advertisement was successful in getting the user's attention, e.g., whether the user clicked on the advertisement (in the Internet environment) or whether the user watched the advertisement and did not issue channel change or volume down commands (in the television environment).

Once the feedback has been obtained, the next step (step 209) is to update the stored profile vectors with such feedback information, so that the feedback information may be utilized in the future. This feedback information includes information on which advertisements have higher rates of success. However, by the use of profile IDs, the displayed advertisements may also be matched with stored profile vectors. Thus, the success rate of a particular type of advertisement also corresponds to a particular type of profile vector. For example, the feedback information may show that some advertisements are more successful with certain types of profile vectors than others. In an exemplary case, the feedback information may illustrate that profile vectors corresponding to higher income groups are more receptive to advertisements having classical music as backgrounds.

All such types of feedback information are useful in the selection of future advertisements and thus are incorporated within the operation of the evaluator.

It should be noted that steps 201-203 are preferably executed in real-time implying that the user is presented the advertisement within a few milliseconds of the transaction. However, step 205 may be executed in real-time or may be executed at a later time.

It should also be noted that in a preferred embodiment, the user's identity is kept completely anonymous and a random ID attribute is the only indicator that is utilized to identify profile vectors and corresponding advertisements. However, in alternative embodiments, secure correlation servers may be utilized to create individualized profile vectors while keeping private information about the user secure.

For example, the secured servers may be utilized to create individualized composite profiles. Different levels of privacy are maintained by different levels of identification in the profile ID. The selection of suitable profile ID attributes may reflect these types of individualized profiles, e.g., 0=completely anonymous, 1=user zip code is used in transaction ID, 2=user residence is used, and Z=user name or personal identifier such as social security number is used.

Based on the identifying attributes in the profile IDs, sets of profiles are linked or correlated. Alternatively, composite profile vectors (aggregated profile vectors) corresponding to different identifying criteria, e.g., regional location, may be created. Thus a composite profile vector created from different types of transactions may be developed based on different anonymous or quasi-anonymous identifying attributes. For example, a composite profile vector for all users at a particular postal zone may be created. As another example, the profile vectors of the residents at a particular street address may be aggregated or correlated. It is to be noted that in the cases of individualized composite profile vectors or sets of aggregated profile vectors, personal information may be utilized to generate suitable individual profile vectors, but this personal information is never disclosed to other parties or utilized for other purposes. Generally, after a secure ID attribute (incorporated into a profile ID utilizing the user's identifying information) has been created, the transaction data associated with the profile as well as any other user personal information is discarded, i.e., completely flushed out of the system.

Unlike the prior art, in the present invention private information about the user is not tracked or stored on a global server. The individualized profile vectors are aggregated to form a set of profile vectors associated by the secure ID attribute. This aggregation is then used to evaluate suitable targeted advertisements. Alternatively, the profile vectors are combined to form a composite or set of composite profile vectors associated with the secure ID attribute. The aggregation or the forming of composite profile vectors is particularly useful, because preference data from the feedback of one profile vector can be correlated against other profile vectors for which no feedback information is available. This also allows cross-platform correlation.

For example, the profile vectors for several television viewing sessions may be aggregated with profile vectors from retail purchase transactions and web surfing sessions. If a system configured in accordance with the principles of the present invention receives a request for the selection of an advertisement for a new television user, but had no direct feedback information from television viewing profiles and only feedback for retail purchase transactions, the system selects the advertisement based on the retail purchase feedback of the associated retail transaction profile vector. If the system has some feedback data for each of the associated vectors in the aggregation, the system weighs the feedback information for each of the different types of profile vectors and bases the offer selection on the weighted result. Similarly, variant feedback for similar or same profile vectors of the same type is weighed or statistically balanced during the offer selection process. The updated profile vectors reflect an individualized profile vector that is referenced by a unique and randomly assigned transaction ID having non-deterministic information.

Once the individualized profiles vectors have been created, the individualized profile vectors may be used to generate and present targeted advertisements. The targeted advertisements may be presented in real-time or may be presented in the future, as illustrated in the previous embodiment. The other operations of obtaining feedback information and utilizing feedback information to update evaluators also remain the same as the previous embodiment.

The advantages of using individualized profile vectors include the ability to select targeted advertisements reflecting a better probabilistic measurement of user likes and dislikes. Thus, the user is not flooded with junk, useless information, offers or advertisements, instead the advertisements are selected to better fit the needs and the preferences of the user. It is anticipated that the targeted advertisements are far likely to succeed with the user than traditional advertising. Thus, this embodiment offers advantages for both the user as well as the advertiser/retailer. The user is receiving what he prefers and the advertiser has a higher success rate, while user privacy has been secured. Thus, this embodiment provides a secure, quasi-anonymous system which will return either a set of user IDs in response to a profile inquiry or a correlated offer or offer profile in response to a user ID inquiry.

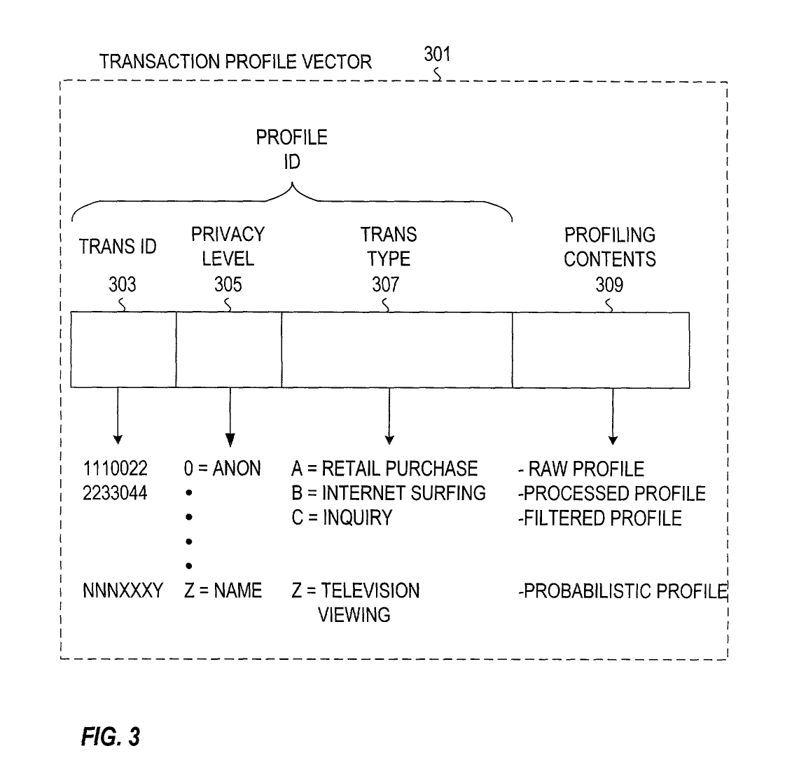

FIG. 3 illustrates an exemplary case of a generalized transaction profile vector 301 according to the present invention. As described above, the transaction profile vector is generally made up of a profile ID and actual profiling contents. The profile ID may have a plurality of component attribute vectors. At a minimum, the profile ID comprises a unique identifier for the profile vector generated from the transaction. In the case of an anonymous profile, the profile ID may simply be a random value. Additionally, the profile ID will preferably comprise other attributes or attribute vectors such as transaction ID 303, privacy level 305, transaction type 307, time or location information, secure ID values, and the like. The profiling contents 309 relate to actual profiling information, e.g., raw profile, processed profile, filtered profile, probabilistic profile etc. Different types of profiling contents are discussed in detail below.

It will be appreciated that any or all of the these attributes could be incorporated into the components of the profile vector. However, it is preferable to exclude any user identification information such as secure ID values from the profile vector component. By way of example, the profile vector 301 may be completely anonymous (ID level=0) or may have one of the individualized levels of privacy (1, 2, 3 . . . N). In the case of complete anonymity, the profile ID comprises a random number or value, but in the case of other individualized privacy levels, the profile ID identifying attribute vector(s) reflecting some user information (e.g., at Z level, the secure ID value may be a user social security number or name).

As shown in FIG. 3, the profile vector 301 may also comprise an attribute that illustrates the type of transaction data 307 from which the profile has been generated. As discussed above, the transaction type 307 may vary, e.g., it may be a grocery purchase (A), clothes purchase (B), etc. The transaction type 307 may not be a purchase at all and may only be a visit to a particular web site or may be the viewing of certain television programs.

In either case, as illustrated in FIG. 3, different types of profiling contents 309 may be generated. The profiling contents 309 may include a raw profile implying that all the transaction data 307 has been utilized to create a profile vector. Preferably, however, the profiling contents 309 are a processed or a filtered profile implying that the raw transaction data has been filtered and processed. In this case, the profile vector is created based on one or more key/triggering items in a transaction, e.g., in the case of a retail purchase, the generic types of purchases may be filtered and the profile may be created based on one or more key purchases, such as very expensive perfumes. Similarly, the profile vector may be based on only probabilistic information. The principles of the present invention are flexible and heuristic rules used to create the profile vector may be selected/amended based on different applications.

One object of the present invention is to provide a system and a method for matching users with advertisements by utilizing a secure correlation server. By the use of this correlation server, the private information about the user is secured, but one or more identifying pieces of information are utilized to select one or more targeted advertisements. This system does not store or track actual user information for long-term use. Instead, it processes the data in a secure manner to create one or more transaction profile vectors.

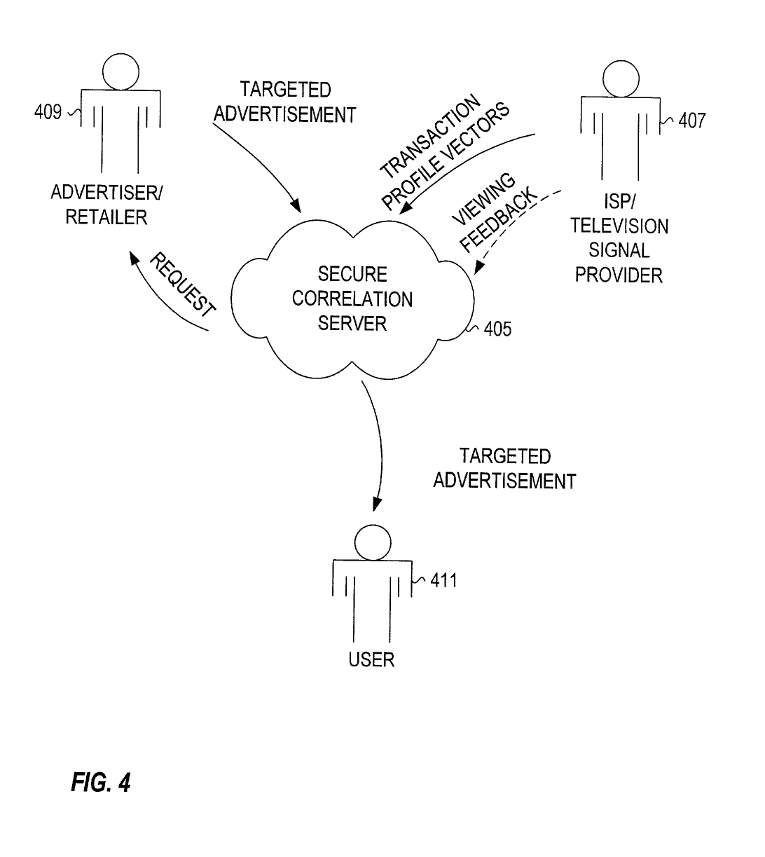

FIG. 4 illustrates a secure correlation server configured to receive transaction profile vectors from one or more sources. These transaction profile vectors are preferably generated locally and transmitted to the secure correlation server 405 or may be received from an external system via a secured connection (not shown). As previously discussed, these transaction profile vectors are based on one or more actions in a transaction, e.g., retail purchases, on-line purchases, television viewing habits, web surfing habits, etc.

The secure correlation server 405 receives these transaction profile vectors from the service/signal provider 407 e.g., an ISP (Internet Service Provider) or television service provider, and stores them in a storage medium along with specific profile vectors, wherein profile IDs are used to illustrate correlation. The secure correlation server 405 then evaluates the transaction profile vector components in accordance with some pre-defined heuristic rules and selects a suitable targeted advertisement.

These targeted advertisements may be stored locally in the secure correlation server 405 or may directly be transmitted to the user 411 from an advertiser server. In the case where advertisements are not locally stored, the secure correlation server 405 transmits a request for an offer to an advertiser/retailer 409 and, in response, a targeted advertisement is received by the secure correlation server 405 to be presented to the user 411. This targeted advertisement generally has a tracking code comprising or linked to the specific profile ID.

There are many different ways to ensure that the computed transaction profile vector is based on current user preferences or is updated regularly to illustrate the current selection. In one embodiment, the user data from older transaction profile vectors is completely discarded after a pre-determined number of transactions, and the profile is re-created based on the current data. Alternatively, a weighting strategy may be used where older transaction profile vectors may be assigned lower weights and newer transactions may be assigned higher weights. Other ways are also envisioned and are known to one skilled in the art.

The present invention offers many other advantages, e.g., the decision making is occurring in a real-time. Furthermore, the computing requirements may be reduced by using distributed systems, e.g., actual profile vectors are generated locally or are generated at a high-level network server which stores the information, processes it and then transmits it by a secured connection. In either case, the actual transaction data as well as the private information about the user is discarded. Once discarded, the actual transaction data as well as private information is not available for any other purposes. Generally the transaction data and the user private information are completely flushed out of the system. This ensures user anonymity and minimizes the risks that hackers may break into the system and steal user information.

In one embodiment, the principles of the present invention may be utilized to provide a privacy protected profiling and profiling system. This embodiment combines the principles of filtering and profiling wherein a filtering agent filters out the unnecessary contents. At the same time, a profiling module creates profile vectors based on user preferences, interests, transactional behavior, and other habits.

The system may be used for Internet browsing, but also may be used in other networked systems such as in television viewing or retail purchase situations. The system is not dependent on persistent state technology and therefore can be used in broadband television networks such as digital cable television and interactive television systems and in retail store point-of-purchase and offline marketing systems.

Generally, the profile vectors are created and saved locally at the user point of transaction. Access to profile vectors is preferably controlled by the user, e.g., the user may choose to provide these profile vectors to one more external sources in exchange for one or more value propositions. These value propositions may be offers such as discounts, cash or just the attraction of receiving more targeted relevant advertisements. In world-wide web browsing, the value proposition can be, for example, access to value added content on a web publisher's website. In a television environment, the value proposition can be a free premium cable service. Thus, a system in accordance with the principles of the present invention, provides not only filtering chosen by the user, but, it also creates profile vectors that are saved locally, and are controlled by the user. The user may view the profile vectors, delete them, save them in storage medium, e.g., in a profile vector file. The user may also choose to sell his profile vectors in exchange for one or more incentives. The incentives may be based on promotional items. In other instances, the value of the incentives may be based on an unrestricted access to the contents of web site.

The profile vector may be based on one or more demographic characterizations representing a probability that a consumer falls within a certain demographic category such as an age group, gender, household size, or income range.

The demographic characterizations may also include one or more interest categories. These interest categories may be organized according to broad areas such as music, travel, or restaurants.

The profile vectors generally contain information beyond user identifying information. This information will vary by transaction type. For example, in web browsing, a local profile vector generator creates profile vectors having interest data from the web browsing activities of the user, i.e., the subject matter of the web pages viewed by the user. In a television viewing situation, each profile vector may contain data about the user's viewing preferences as well as transactional data such as frequency of channel changes. In some instances, the profile vector generator is programmed to supply inferred data from the user's transaction behavior such as inferred demographic probabilities due to, for example, the content and context of the transaction. An example in television viewing is inferring the sex of the viewer or viewer audience from the content of the programs being viewed.

In the preferred embodiment, the raw transaction data is not contained in the profile vector, only attributes processed from the transactional data are included. Thus, no permanent record of an individual's behavior is maintained and the individual's privacy is protected.

The user may also choose to provide his profiling information stored in profile vectors to various sources at different levels. At the lowest level, the information provided is generic in nature, e.g., interests, hobbies, lifestyle, but no user identifying information is disclosed. At the highest level, an unrestricted access is provided to the profile vectors and the user may disclose one or more identifying features, e.g., his name, ID, e-mail, etc. In another instance, a medium level may be chosen, e.g., the user's e-mail address is disclosed, but not the actual name, and postal address. Other different levels are also envisioned. The user has an option in choosing a level that he feels most comfortable with on a case by case basis or according to predetermined preference rules. Furthermore, the user may change his options any time. For example, the user may provide full access in some instances and no access in other instances.

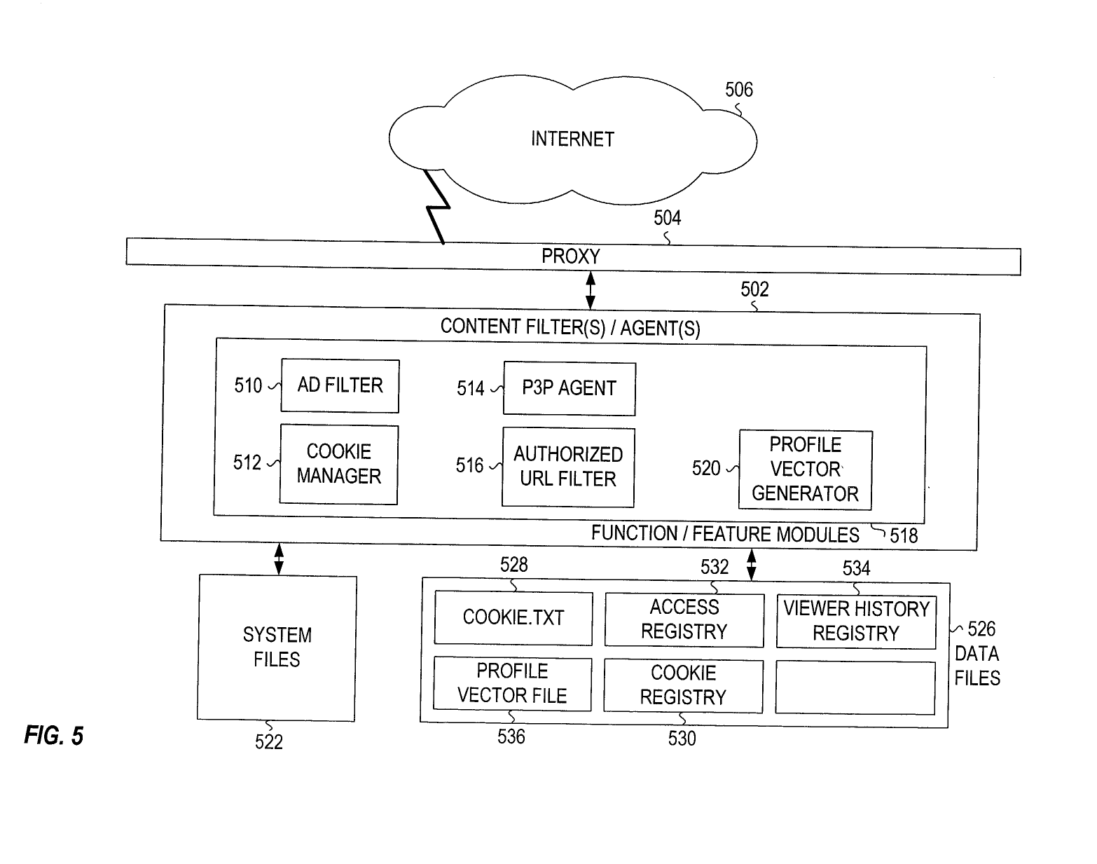

FIG. 5 illustrates one implementation of the present invention in web browsing environments. A system in accordance with this implementation comprises a content filter/agent layer 502, which is configured to directly communicate with a computer-based network, e.g., the Internet 506, through a proxy 504. Alternatively, the filter could be incorporated directly into the browser application rather than being placed between the application and the Internet 506.

Content filter/agent layer 502 comprises one or more different types of filtering means that filter out the contents of the incoming information. The main purpose of the content filter/agent layer 502 is to filter out the information based on the parameters set by the user and/or advertiser but generally the user is provided control of the information.

Content filter/agent layer 502 protects the user privacy at many different levels, e.g., it may make the user completely anonymous by not allowing any cookies to go backward or forward. Content filter/agent layer 502 may also permit the user to selectively allow cookies to go through, or to be placed in storage. By doing it selectively, the user may permit a trusted brand-name company to place a cookie, but not companies with whom the user is unfamiliar. The user may add a list of the permitted URLs in a registry database and the content filter/agent layer 502 may access this list to determine whether the cookie should be rejected or allowed.

In an exemplary case, the content filter/agent layer 502 comprises a plurality of agent modules configured to monitor, edit and generate information. As shown in FIG. 5, content filter 502 comprises an ad filter 510, a cookie manager 512, a P3P agent 514, and an authorized URL filter 516. Collectively, these agents are known as function/feature modules 518. The purpose of the ad filter 510 is to filter out all or certain ads. The user may choose not to receive any advertisements during a viewing session that can be an Internet surf session or a video program session.

Alternatively, the user may choose to filter out selective ads such as those not from an authorized source. In a similar fashion, cookie manager 512, based on user initiated configuration, either blocks the cookies, selectively permits the cookies, or places the cookie in an alternative storage medium similar to a cookie jar. The P3P agent 514 provides security and protects user private information such as name, address, or telephone number in accordance with the W3C Platform for Privacy Preferences Project (P3P) standards using, for example, the W3C APPEL ordered rule-based language to negotiate access to data in the P3P data set. The authorized URL filter 516 contains a list of URLs authorized by the user to communicate with user's computer, e.g., transmit information, place cookies, etc.

Thus, the content filter/agent layer 502 may provide filtering blocks at a level selected by the user. The user may select a complete block (i.e., block everything), or, alternatively, the user may select an intermediate block (allow a few things and block others).

In the exemplary case of FIG. 5, content filter/agent layer 502 also comprises a profile vector generator 520 configured to generate profile vectors based on user viewing sessions. The viewing session may be based on user's Internet access activity records, e.g., history logs, or may be based on the information collected about the user, e.g., cookies permitted by the user. In the cases of video programming, the viewing session may comprise a program viewing session.

In FIG. 5, content filter 502 is also shown to be configured to communicate with a plurality of data files 526. The information received or generated by content filter/agent layer 502, including profile vector generator 520 is stored in one or more data files 526. For example, cookie.txt 528 includes information from the cookie present on the hard-drive. The cookie registry 530 includes all the cookies permitted to reside at the user computer. Access registry 532 includes the list of URLs accessed by the user. Access registry 532 emphasizes two features in its accumulation of information, i.e., “recency” and frequency. In one example, the information about recently accessed URLs is recorded, and the older information is regularly purged. Similarly, the frequently accessed URLs carry more weight than infrequently accessed URLs. Viewer history registry 534 is comparable to a known history log and comprises a brief history of user access to the Internet. The actual profiling information relating to profile vectors is stored in profile vector file 536. The nature of the profile vectors is discussed in detail below.

The content filter/agent layer 502 communicates to a network, such as the Internet 506, via a local proxy 504. The proxy 504 controls user access to the Internet 506, e.g., provides security, completes handshake, etc.

Note that even though on FIG. 5, profile vector generator 520 is shown to be part of the content filter/agent layer 502, it is envisioned that the profile vectors may be generated by a means located external to the content filter/agent layer 502, e.g., an external software module.

In one implementation, the content filter/agent layer 502 is a software means and resides on the user computer and has access to system files 522. The content filter/agent 502 software may be programmed to run on specific operating systems such as Microsoft Windows or Linux. Preferably, however, the content filter/agent 502 software is programmed in Java and runs on any Java Virtual Machine software. This makes the content filter/agent 502 software independent of the operating system. Alternatively, the features of the content filter/agent layer 502 may be incorporated within an existing application, e.g., a web-based browser. In this case, when the user accesses the Internet 506 through his browser, he receives all the features of the content filter/agent layer 502.

The content filter/agent layer 502 may be designed in many different ways, e.g., it may be designed in the browser or as a plug-in to the browser. It may also be based on the local proxy 504, i.e., adding this filtering capacity onto the local proxy. Roughly, a proxy 504 is set as an application that runs on the operating system. The browser first accesses the proxy 504 and then accesses the Internet 506.

Furthermore, an Internet Service Provider (ISP) may act as a proxy 504. In this case, the proxy 504 will reside at the ISP. This proxy 504 may contain the files (databases) to identify a different log, feature, etc. There may also be a cache proxy where they will actually hold in their memory at the ISP, copies of all the most frequently accessed pages. In this case, the Internet 506 need not be accessed every time a particular Web page is accessed. This results in faster speed and efficiency.

Content filter/agent layer 502 may be set at the proxy 504. In this case, when an hypertext transfer protocol (HTTP) request is transmitted, the proxy content filter can strip certain portions of the information from the outgoing request. Similarly, when the information contents in response to a HTTP request are received, the proxy content filter removes certain portions of the information (in accordance with the parameters set by the user). When the proxy content filter sees a cookie, or a cookie request, it can strip that information as well, or alternatively, it can take that information and put it in its own storage medium, e.g., a cookie jar. In sum, the proxy content filter can be programmed to do all the above-mentioned features or more or only some of them. Ultimately, the choice is left up to the user. For example, parents who do not want their children to access pornographic websites, can create a blocking agent in the proxy content filter by describing some key words, or a list of URLs in the filtering means. When the proxy content filter receives those words or sees an HTTP request to those URLs, it blocks the access, and generates a local message to the requester indicating that “access to the requested sites has been blocked”.

The principles of the present invention are equally applicable for television environments. In a television environment, the user profiling may be performed in a STB. Each STB may act as a local profiler and be responsible for profiling a single household. A head-end system may provide the STB with program and channel map data and the channel map may convert the user perceived channel indicator (UPCI) into a network identifier so that programming information can be extracted from the program database. The STB may monitor the behavior of the viewers, and with the assistance of the program data, derive characteristics about the household and individual viewers.

Some of this data may be transmitted back to the head-end in a secure manner for processing while the rest may be stored internally on a non-volatile memory device. The head-end may compress the program information to fit in the resource-limited STB. The program data may be transmitted down to the STB periodically. When the STB has updated profile vector information about a household, the head end may receive this data and store it in a profile vector database.

Furthermore, when the profiling application runs on the STB and generates profile vectors that may be transmitted to the head-end, the profiling application may consist of a user interface, event queue, clock, profile engine, profile filters, program database, and communications manager. Many of these components may work independently of one another. Furthermore, a user interface may allow the viewer to turn the STB on and off, change the channel, and determine to which channel the STB has currently been tuned.

In a STB simulation, the user interface may also allow the operator to select a household to profile and view changes to the profile vector in real time. An event queue may store both viewer-generated events and internal events, and the events dispatched to the profiling engine may be based on the clock time. Viewer-generated events include a power on, power off, and channel change.

Each of these events may change the state of the system and the user's profile vector. The clock may run independently within the system and may be used to mark the time that events occur and trigger internal events to trap when programs change. Furthermore, the clock may run in its own thread and allows for time to elapse at different rates.

Thus, the profiling application located within the STB may accept events from the event queue, read database information, and process the events to produce the user profile vectors. The profiling application may also periodically transmit updated profile vectors back to the head end for archiving and analysis. The updated profile vectors may be forwarded to the user interface for display. Furthermore, the profiling application may use one or more filters to process events. Each filter may handle a single profile element and each event may be passed to every filter, wherein the filter determines whether the event is applicable to its profile vector. The profiling application may also query each filter for updated profile vector information after every filter has processed an event. This data may then be passed to the user interface.

The program database may also store program and network identifier information wherein the head-end will have the full program information in a program database, e.g., a Structured Query Language (SQL) database. The STB may only receive a subset of the applicable information to reduce the data requirements. A communications manager may handle the communications between the head-end and the STB, wherein the communications manager must receive database downloads and transmit updated profile vector data.

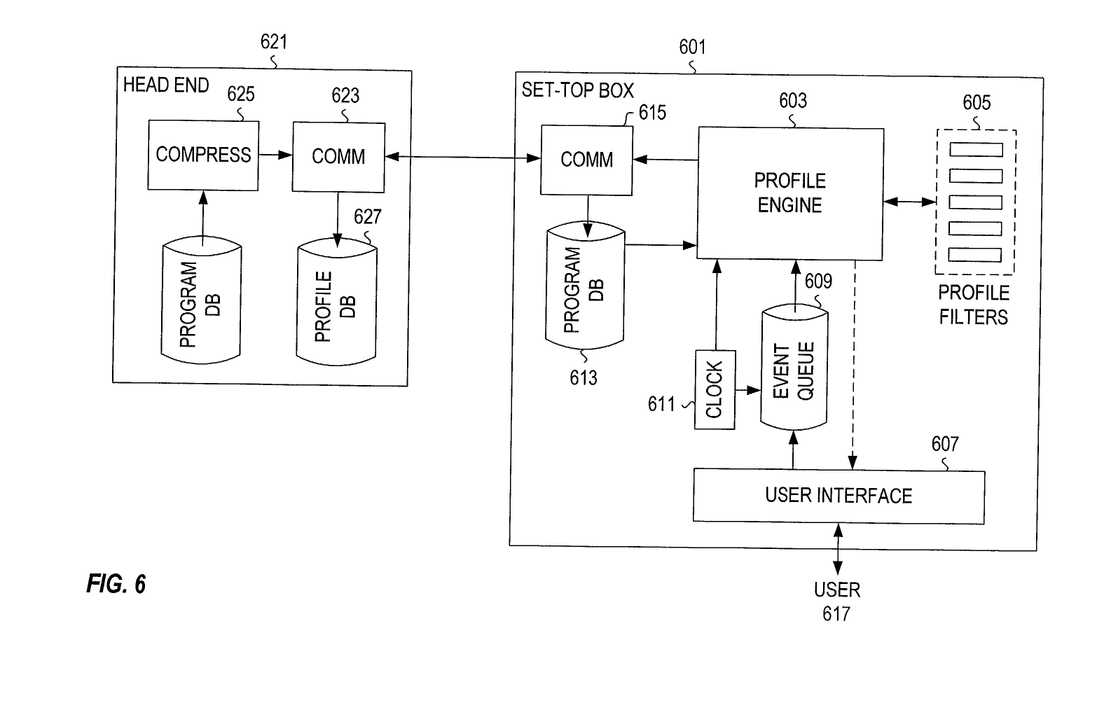

FIG. 6 illustrates an exemplary implementation of the present invention in a television environment. A STB 601 comprises a profile engine 603 (profiling application) connected to one or more profile filters 605. Directly connected to the profile engine is a user interface 607. The user interface 607 collects profiling information from the user 617 and reports to the profile engine 603 in the form of event queue 609. The event queue 609 communicates to the profile engine 603 via a clock 611.

The profile engine 603 is also coupled to a program database 613 wherein the program database 613 stores the relevant information. The profile engine 603 communicates to the head-end 621 via a communications interface 615 wherein the head-end 621 receives information from STBs via a communications interface 623. The head-end 621 is capable of compressing large amounts of profiling information collected from a plurality of STBs via a compressor 625, wherein the actual compressed data is stored in profile databases 627.

In the system of FIG. 6, the profiling data is communicated from the STB 601 to the head end 621 in a protected manner, e.g., deterministic features about the user are not communicated. The user name, address, and other known features are not used to store or transmit profiling data, instead random or arbitrary numbers may be used. In one embodiment, each transaction (television viewing over a pre-determined period) is recognized by a random ID and the MAC-ID of the STB 601 is utilized to compile the profile vectors. Other similar mechanisms may also be used.

The local profiler is useful for audience measurement. For example, where gender and age may be inferred by the profile generator, the set-top box may be polled to send or report back to the headend the channel or network identification, and the probable audience composition, e.g., gender and age of the viewer, at periodic intervals. This can be accomplished anonymously on a cable system-wide basis thereby providing the cable operator with viewing statistics, since no household or personally identifiable information needs to be transmitted from the set-top box.

The above-described implementations only provide a few embodiments of novel means of anonymous profiling, some of them not available in prior art. But, the crux of the invention lies in the generation of local profile vectors.

It is also to be noted that the user privacy is completely protected during the generation of the profile vectors. First, the profile generation is performed locally, e.g., at the user's networked appliance such as a computer or interactive television or set-top box. Secondly, the profile vectors are stored locally, e.g., at the user's computer and no authorized access to this information is provided. The operation of profile vectors is dissimilar to the use of cookies, and there is no transmission of information without the user's knowledge/explicit permission. Third, the actual transaction information, e.g., the actual viewing data is preferably discarded after the generation of profile vectors and is not sold or made available to third parties except with the user's explicit permission. Finally, the user is not required to, but may optionally, provide private information for the generation of profile vectors and the profile vectors may be tracked by virtual identifiers, e.g., a profile vector may be assigned a random ID, not relating to his personal information and this ID may act as a profile vector identifier.

In the web browsing implementation, the profile vectors are based on the viewer's browsing session and an interest characterization algorithm associates an interest category and interest strength with the viewing history of the user. The web pages sent to the browser are passed through the content filter/agent layer and the profile vector generator where the pages, typically formatted in Hypertext Markup Language (HTML), are parsed and information about the page is extracted and analyzed. For example, the URL of the sending server, the metadata such as metatag values and document name, and the document text are analyzed to determine the interest category or categories of the requested page. Preferably, the profile vectors are based on one or more interest categories, e.g., the list of URLs accessed, the frequency of access, the recency of the access, and the inferred interest category. The data is inferred because the original data is parsed based one a predetermined algorithm. The algorithm is based on analyzing one or more categories, e.g., the algorithm may analyze the interest category of a particular page. Furthermore, the algorithm is configured to disregard common terms in its analysis, e.g., the algorithm takes into consideration that most pages have the word “copyright” on them and ignore that fact, because they would think that everyone had an interest in copyright. Similarly, HTML tags are also filtered out by the algorithm.

Below is one example wherein the profile vector includes data structured according to the following high level structure:

privacy level

level
descriptive

deterministic

name
address
phone
social security number

demographic

age
gender
nationality
income level

interests

category 1
category 2
etc.

preferences

category 1
category 2
etc.

transactional

type

relative

community
family

inferred

Generally, the profile vectors, generated in accordance with the principles of the present invention, protect anonymity and do not require users to disclose/provide private information that is deterministic in nature. However, if a person voluntarily entered their deterministic information, name, address (street, city, zip), that information could voluntarily be available as part of any of the profile vector.

Several different types of profile vectors may be generated. For example, preferences and interests may be nested into transactional information. Alternatively, the transactional information should be nested into preferences and interests e.g., a subcategory of preferences may be created.

In one example, assuming that the profile vector record is being generated from a television viewing session where the viewer turned on the television at approximately 7:30 pm, watched 9/10th of a “Seinfeld” sitcom, changed the channel frequently, and watched 8/10th of the “Third Rock from the Sun” sitcom, then started and is in the middle of watching another program, “Who Wants To Be A Millionaire?”. The profile vector based on this information will probably include that the viewer has an interest in humorous entertainment and specifically sitcoms.

Thus, assuming the above-noted profile vector data structure, a profile vector record may be populated as follows:

privacy level = 1

level = 0 (anonymous)
descriptive = 25x3u1qr728 (random profile id)

deterministic = 0

name = 0
address = 0
phone = 0
social security number = 0

demographic = 0

age = 0
gender = 0
nationality = 0
income level = 0

interests = 1

category 1 = <television_viewing>1</television_viewing>
category 2 = <humor>1</humor>
etc.

preferences = 1

category 1 = sitcoms

Seinfeld = 0.9
Third Rock from the Sun = 0.8

category 2 = 0
etc.

transactional

type = television viewing

average dwell time = 4:26
session duration = 1:12:34
start time = 19:24:37

relative = 0

community = 0
family = 0

inferred = 0

It should also be noted that in television environments, the profile vectors may be generated by any known software or operating system means, e.g., Java or Windows software may be used. In one implementations, a binary file in any known data format such as dbase (DBF) file format may be created. In Internet environments, preferably, the profile vector is formatted and stored in Extensible Markup Language (XML). XML is a flexible method for creating a consistent way to sharing information over the Internet, intranets, or anywhere else. It is basically a simplified set of the Standard Generalized Markup Language (SGML). The use of XML for “tagging” data allows for a more defined and accurate way to search data. XML-enabled documents use semantic markup that identifies data elements according to what they are, rather than how they should appear. As a result, many different applications can make use of the information in XML documents.

As an example, an XML profile vector for the above-noted example would look something like this (where “profilevector.dtd” defines the XML Document Type Definition):

<!DOCTYPE profilevector SYSTEM “profilevector.dtd”>
<profilevector version=“0.3”>
<privacy>

<level_privacy>0</level_privacy>
<field_privacy>25x3u1qr723</field_privacy>

</privacy>
<interests>

<television_viewing_interest>1</television_viewing_interest>
<humor_interest>1</humor_interest>

</interest>
<preferences>

<sitcoms_preference>

<Seinfeld_sitcoms_preference>0.9</Seinfeld_sitcoms_preference>

<Third_Rock_sitcoms_preference>0.8</Third_Rock_sitcoms_preference>

</sitcoms_preference>

</preferences>
<transactional>

<television_viewing_transaction>

<average_dwell_time_television_viewing_transaction>4:26</average_dwell_time_te
levision_viewing_transaction>
<session_duration_television_viewing>1:12:34</session_duration_television_view
ing_transaction>
<start_time_television_viewing_transaction>19:24:37</start_time_television_vie
wing_transaction>

</television_viewing_transaction>

</transactional>
</profilevector>

As discussed before, the profile vectors may be based on more than one transaction or viewing session. For example, the profile packets may reflect information from the past few transactions. However, the recency is important to the process of accurate profile vector generation. For example, the user may have regularly viewed “NYPD Blue” a few months ago, but since David Caruso left the show, the user has stopped watching the show. Thus, the viewing information relating to “NYPD Blue” is old and carries less importance. In one implementation, a weighing strategy may be used where recent transactional or viewing data carries more weight than the older data.

Ultimately, the purpose of accumulating profiling information and generating profile vectors is to give the user an option on how to utilize this information for his personal benefit. For example, the user may choose to sell/provide this information to advertisers for receiving targeted advertisements and promotional items. These items may also include access to the information contents not available to general public. The profile vectors may also assist the user in receiving advanced information, e.g., the user may request advanced information on stock market quotes.

The actual transmission of the profiling information may be accomplished by utilizing existing means. For example, the user's computer may contact a network-based server and upload all the relevant information. Alternatively, a network-based server may contact the user computer and extract this information.

Once the profile vectors have been received by a network-based server, these profile vectors may be evaluated by the server to generate targeted advertisements, promotional items, etc., for the user. Different means for evaluating profile vectors and selecting suitable advertisements have been disclosed in Applicants co-pending U.S. patent application Ser. No. 09/268,526 filed on Mar. 12, 1999 entitled “Advertising Selection System Supporting Discretionary Target Market Characteristics” and Ser. No. 09/204,888 filed on Dec. 3, 1998 entitled “Subscriber Characterization System”, both of which are herein incorporated by reference.

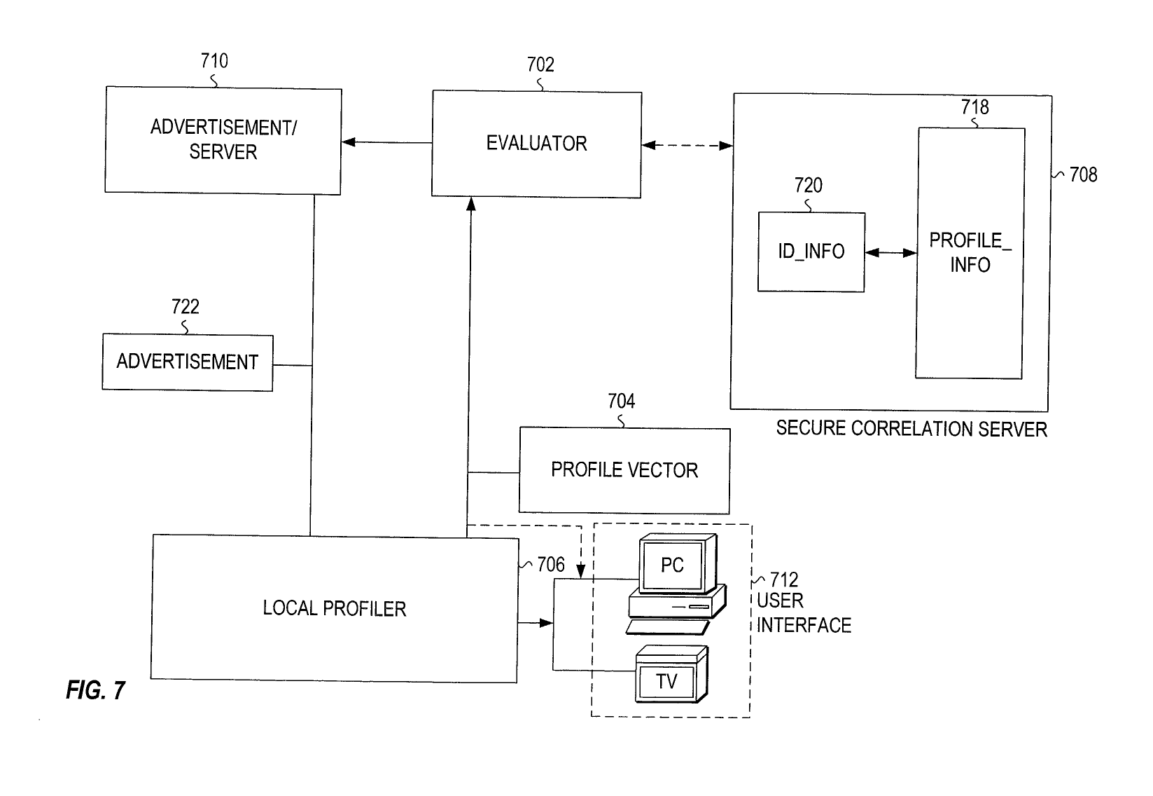

FIG. 7 illustrates an exemplary case wherein an evaluator 702 receives an actual profile vector 704 from the a local profiler 706, wherein the local profiler 706 receives user transaction data from the user interface 712, wherein the user interface 712 may include a personal computer or a television. As discussed before, the profile vector 704 may include one or more different interest categories. Based on the configuration, the evaluator may use one or more pieces of deterministic information identifying user's identity. For example, the profile vector may include the MAC_ID of the transmitting STB. Alternatively, the profile vector may only include random ID that identifies the origination source of the profile vector, but no other deterministic features.

If one or more deterministic features are present, the evaluator 702 communicates to a secure correlation server 708 for correlating the user identification with the previously stored profile vector information. This correlation helps to identify the user's preferences and interests and thus assist in providing one or more customized/personalized incentives/offers to the user. It is contemplated that identity correlation would only be done with the user's explicit permission, for example, on a subscription basis.

Secure correlation server 708 generally comprises a storage medium that holds profiling information 718. The profiling information is generally referenced by ID_INFO 720. The secure correlation server 708 may be a network-based server, configured with one or more privacy-protecting features. For example, this server may be protected by a firewall to restrict unauthorized access attempts. It is to be noted that the use of a correlation server is optional, and the profile vectors may be evaluated by evaluator 702 without having correlation features such as when the profile vector ID is devoid of deterministic data or the user has not granted permission to correlate.

Generally, evaluator 702, with or without the use of secure correlation server 708, evaluates the received profile vector and forwards its evaluation to an advertisement server 710. Advertisement server 710 utilizes the received information to determine one or more advertisements 722 that may be of interest to the user, and then forwards the advertisements to the user interface 712. The advertisements may include one or more incentives including promotions, discounts, or free gifts. In one implementation, the advertisement is negotiated before user 706 transmits the profile vector to evaluator 702, e.g., the user may already have been promised a 30% discount on the next purchase in exchange for profiling information and acceptance of the advertisement.

The advertisements are generally transmitted via broadcast means such as television signals or Internet traffic. The advertisement may also be transmitted to the user via traditional means, e.g., via e-mail or via regular mail. Alternatively, if no deterministic information is available, the profile vector ID may be used to determine the identification of the origination computer and the advertisement may be transmitted to the origination computer. Furthermore, the user may provide instructions on how he wishes to receive the advertisement, and the advertisement may be transmitted in accordance with those instructions.

Generally, all profile vectors include one ore more basic interest categories. However, these basic profile vectors may be enhanced by incorporating additional actual or inferred information. For example, estimated income level may be inferred from the existing information. Additionally, weighing values may be assigned to a predetermined set of categories resulting in a weighted interest profile vector.

Additional interest categories may be created by utilizing publicly or privately available user-information databases.

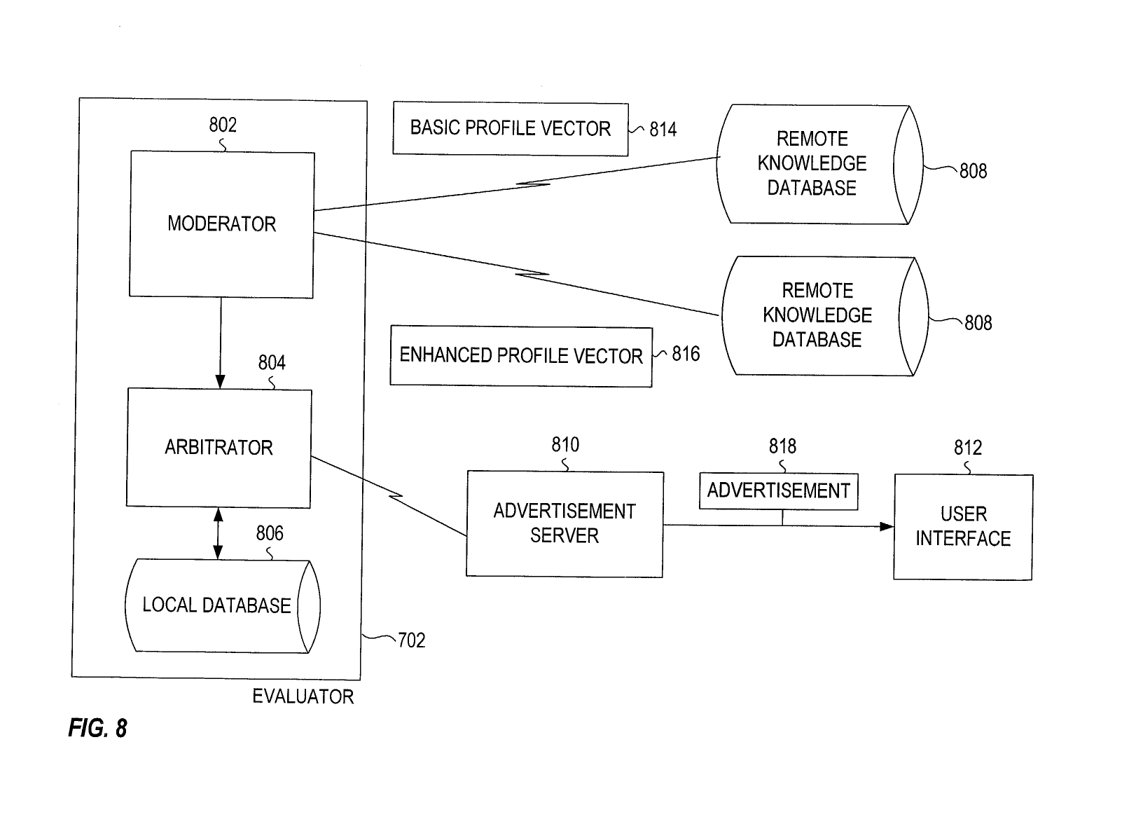

FIG. 8 illustrates an exemplary implementation of the profile exchange subsystem of the present invention. In this exemplary case, the evaluator 702 of FIG. 7 further comprises a moderator 802, an arbitrator 804, and a local database 806. Local database 806 includes data files and other information about the user or user's profile vectors such as archived profile vectors and their corresponding advertisement receptivity levels.

One or more remote knowledge databases 808 receive basic profile vectors 814 from moderator 802 and processes it to create an enhanced profile vector 816. The enhanced profile vectors 816 are returned to evaluator 702. Databases 808 could be located remotely and connected by a telecommunications link to the targeting evaluator via, for example, the Internet, or could also be located locally with the evaluator.

In FIG. 8, the basic profile vector 814 may comprise location attributes of the targeted user such as <state> and <county>. An XML example of a basic profile packet for county 021 in Wyoming, USA is as follows:

<profilePacket>
<profilePacket_id>xa19w27qxg</profilePacket_id>
<state>WY</state>
<county>021</county>
</profilePacket>

After the basic packet has been enhanced with the information from remote database 808, the enhanced profile vector 816 comprises additional inferred categories based on demographics, e.g., <income level>, <household size>, <lifestyle>, etc. For example, an XML enhanced profile vector based on the above location may be as follows:

<profilePacket>
<profilePacket_id>xa19w27qxg</profilePacket_id>
<state>WY</state>
<county>021</county>
<inferred>

<city_slicker>13%</city_slicker>
<country_bumpkin>2%</country_bumpkin>
<high_income>45%</high_income>
<married_with_children>35%</married_with_children>

</inferred>
</profilePacket>

Thus, when compared to the basic profile vector, the enhanced profile vector comprises additional information that assists in determining targeted advertisements that may be of interest to user. Since no personally identifiable information associated with the intended target has been used to retrieve the enhanced profile vector, the privacy of the targeted user is protected. Profile information can therefore be exchanged anonymously or pseudonymously between third party data provider or aggregators such as Claritas and the targeting server.

In one implementation, arbitrator 804 receives the enhanced profile vector, evaluates all the categories of the enhanced packet, and then assigns weights to each category based on importance, e.g., more deterministic information carries more weight than the generic type information. As an example, if it is known from the profile vector information that the user has a particular interest in sports cars, that information carries more weight than the information indicating that the user purchases groceries every two weeks.

Arbitrator 804 is also coupled to one or more local databases 806 wherein arbitrator 804 may receive additional information about the user being profile vectors and may incorporate this information in the final decision making. Generally, the information from local databases is only useful if the user has provided one or more deterministic pieces of information that may be used to link the current profile vector data to the data stored in the local database 806. In the case of complete anonymity, there is no capability to link the profile vector information to the information from local database 806. In those instances, arbitrator 804 generates a decision factor based on the data included in the profile vectors.

The local databases 806 may also comprise data on advertisements that were previously transmitted to the same user and the success rates of these advertisements. This information is incorporated in the decision factor.

Arbitrator 804, based on the information available, generates a decision factor that is forwarded to advertisement server 810. The decision factor assists advertisement server 810 in selecting a suitable advertisement 818 to be transmitted to user interface 812. Generally, an advertisement is selected is that is most likely to succeed, i.e., have a response from the user. In the case of television programming, the success rate is implied from the fact that the user did not change the channel during the display of the advertisement. In the on-line world, the success rate may result from the fact that the user had clicked on the banner advertisements.

Advertisement (ad) server 810 may comprise an “avail database” (not shown). The avail database comprises the information about all the available opportunities of the advertising. Lately, many Internet companies as well as cable companies have employed ad management systems that record the information about available advertising opportunities. This information is made available to one or more ad servers so that servers can select ad opportunities and transmit advertisements for those opportunities. In the present invention, ad server 810 may utilize the avail information to select an appropriate opportunity for the transmission of the advertisement and then use that opportunity to transmit a targeted advertisement to the user. After the advertisement has been transmitted to the user, the success rate may be monitored by monitoring the response to the transmitted target/advertisements. In the case of secure IDs, i.e., where some user identification information is available, the success rate may be linked back to the user and this information may be stored in the local database 806 via a back haul link (not shown). This information helps in identifying the type of advertisements that are of interest to the user and have been successful in the past. As mentioned previously, arbitrator 804 may incorporate this information in its decision factor that is transmitted to advertisement server 810.

One relevant example is based on the use of commonly known geography-based databases. These databases are generally based on psychographic analysis that attempts to segment consumer lifestyles into identifiable characteristics.

In one example, each geographic datapoint such as street address and radius provides a distribution of households that are in each of predetermined profile vector definitions. In other words, every household is slotted into one of several predefined profile vectors. Based on further empirical studies, the likely preferences and interests of a profile vector member are determined.

These databases comprise demographic, interest and other useful information related to consumer behavior habits. These databases may comprise publicly available information, e.g., census data, market data, stock market data, home sales, tax assessment data. Additionally, these databases may comprise privately collected information, e.g., information based on cookies, surveys etc. Many such databases are known in the market. Engage, Claritas, and Excite are only few of the companies know to possess such databases.

The appeal of utilizing these databases is that they already have the preference and interest data correlated against their profile vector definitions and all you need to give them is the geographic datapoint. The present invention incorporates these profiling concepts, and generates profile vectors that are much broader. For example, the profile vectors of the present invention go beyond the statistical demographic analysis and incorporate the analysis of behavioral data that is or will become available on a networked appliance.

In one implementation, television surfstream behavior is incorporated in the actual generation of profile vectors. For example, the user's viewing habits are monitored and his interests (viewer likes sitcoms) and preferences (viewer prefers “Seinfeld” and “Third Rock from Sun”) are determined. This information may then be correlated with heuristic rules (e.g., age group is probably 25-35) (a) to psychographically derived correlations or (b) to previously-derived, empirical (i.e., demographically-independent) correlations (e.g., 67% of viewers with this viewing profile vector responded favorably to funny VW ads) or (c) to both and weight the correlations probabilistically if they are statistically divergent).

In the exemplary case, the profile vector may be further modified by utilizing this type of data. For example, the geographic information available from the geographic database may be used to determine that the profile vector was generated from someone in Laramie, Wyo. In this case, the profile vector will appear as:

<!DOCTYPE profilevector SYSTEM “profilevector.dtd”>
<profilevector version = “0.3”>
<privacy>

<level_privacy>0</level_privacy>
<field_privacy>25x3u1qr728</field_privacy>

</privacy>
<deterministic>

<state_determined>WY</state_determined>
<county_determined>021</county_determined>

</deterministic>
<interests>

<video_viewing_interest>1</video_viewing_interest>
<humor_interest>1</humor_interest>

</interest>
<preferences>

<sitcoms_preference>

<Seinfeld_sitcoms_preference>0.9</Seinfeld_sitcoms_preference>

<Third_Rock_sitcoms_preference>0.8</Third_Rock_sitcoms_preference>

</sitcoms_preference>

</preferences>
<transactional>

<video_viewing_transaction>

<average_dwell_time_video_viewing_transaction>4:26</average_dwell_time_video_v
iewing_transaction>
<session_duration_video_viewing>1:12:34</session_duration_video_viewing_transa
ction>
<start_time_video_viewing_transaction>19:24:37</Start_time_video_viewing_trans
action>

</video_viewing_transaction>

</transactional>
<inferred>

<inferred_second_city_elite>0.027</inferred_second_city_elite>
<inferred_upward_bound>0.062</inferred_upward_bound>
<inferred_gods_country>0.043</inferred_gods_country>
etc.
<tpl_inferred_income_level>0.9</tpl_inferred_income_level>

</inferred>
</profilevector>

The values in the inferred factors are the percentage of the population in a given profile vector group for the described geographic territory of Laramie County, Wyoming. This enhanced profile vector could then be used to do the further evaluation.

Because the geography-based databases contains a large amount of data, it would not be practical to incorporate this inference feature in the profile vector generator on the client-side. However, some inference capability may be added in profile vector generators. A problem with inferences is that the empirical observations will likely modify inference conclusions and the inferring process will be in constant flux. Therefore, most of the inferring process will be on the server side.

Alternatively, the inference algorithms of the profile vector generators are updated periodically to take into consideration newly discovered correlations. From the above information in the profile vector record, an evaluation could be undertaken. The evaluation would, for example, place considerable weight on the content and context of the currently viewed show (this would be the same as in a broadcast situation and might include “content and context” as a factor in the profile vector). The profile vector would be compared to archived profile vectors to determine viewer receptiveness to a particular advertisement. The inference factors are also used to separately correlate to viewer receptiveness if correlation data were available (such as from a demographic correlation database as described above).

The principles of the present invention also support the collection and analysis of a plurality of locally generated profiles, each of which contain a portion of information that is utilized to create an aggregated user profile vector.

In the actual generation of an aggregated user profile vector, the system may receive a plurality of locally generated profile vectors from a plurality of databases and aggregate the received information to create an aggregated user profile vector. In the aggregation of data, the emerging standards, such as XML, may be used for the transport of the data. The actual aggregation may occur at a central server that is coupled to various remote sources for the purposes of collecting data or processing data.

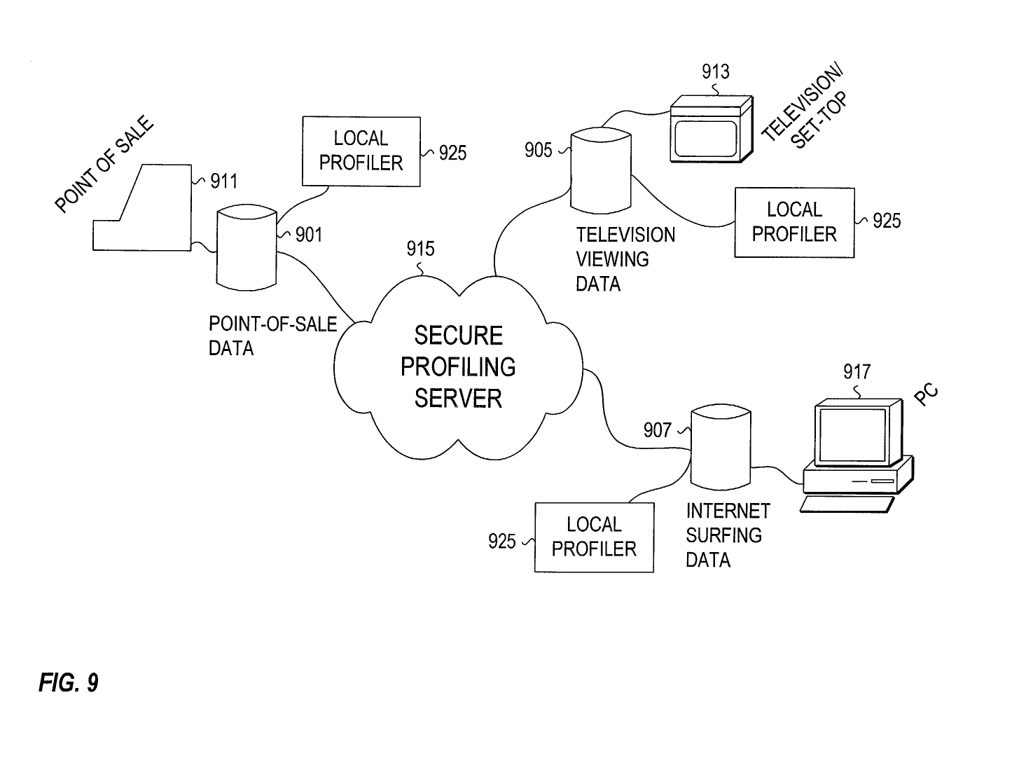

For exemplary purposes, FIG. 9 illustrates a secure profiling server 915 configured to receive a plurality of locally generated profiling vectors from a plurality of sources. The remote sources may be comprised of specific data sets including: point of sale data 901 obtained from a point-of-sale 911 which may be a physical point-of-sale or a virtual (Internet) point-of-sale; Internet surfing data 907 obtained from a PC 917 or other device connected to the Internet; and television viewing data 905 obtained in conjunction with a television/set-top combination 913 or other video centric device.

Each of the remote databases are also coupled to a local profiler 925 that, based on the information, generates one or more profile vectors to be transmitted to the secure profiling server 915. The secure profiling server receives one or more locally generated profile vectors, evaluates them, and aggregates them to generate an aggregated profile vector. The aggregation may be accomplished by the used of a profile ID discussed above, and the aggregated profile vectors may be utilized to match advertisements to user.

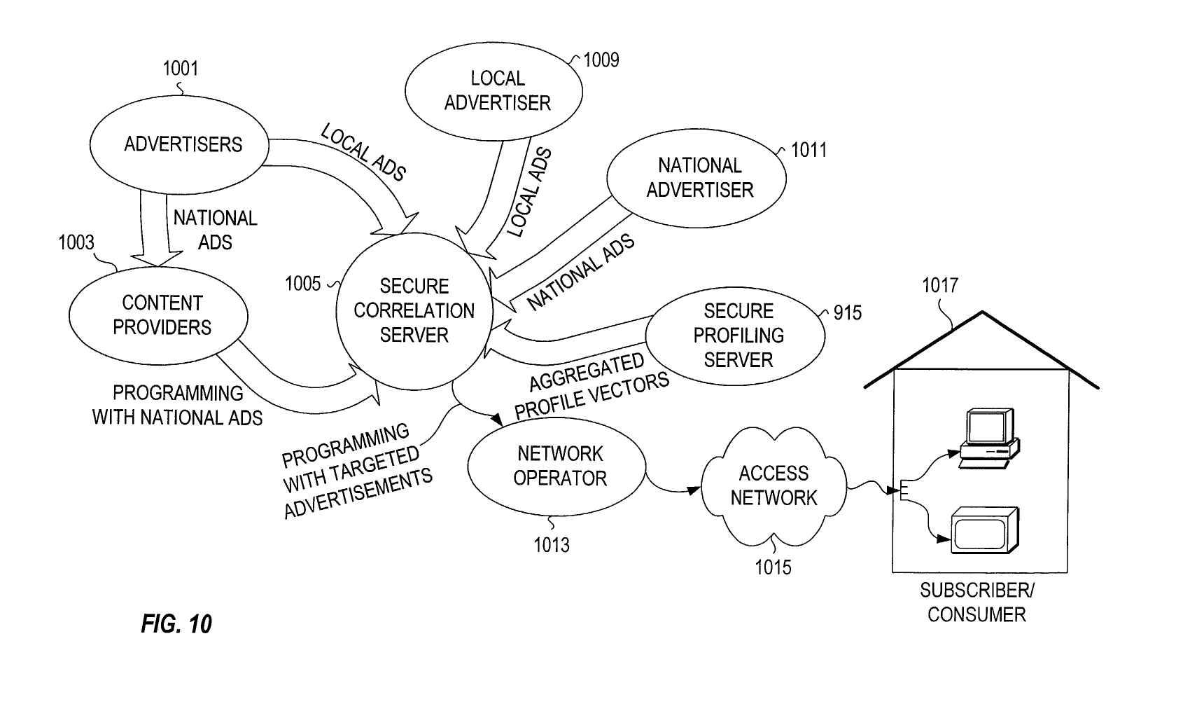

FIG. 10 illustrates an exemplary system based on the principles of the present invention. In this model, the local advertisements are delivered from the advertisers to a centralized Secure Correlation Server™ 1005 configured to perform matching of the advertisements to users or groups of users. At the correlation server 1005, the input is received from a secure profiling server 915 in the form of aggregated profile vectors, and advertisements are matched to one or more users based on the aggregated profile vectors.

As illustrated in FIG. 10, a content provider 1003 receives national advertisements from one or more advertisers 1001, multiplexes the national advertisements in the programming and forwards the program streams having national advertisements to the secure correlation server 1005. The correlation server 1005 evaluates the advertisements and attempts to match them based on the information received from a secure profiling server 915. The secure correlation server 1005, based on the information from the vectors may substitute national advertisements within the program streams with more targeted advertisements received from local advertisers 1009 or from national advertisers 1011. The secure correlation server 1005 may also receive local advertisements from the advertisers 1001.

The secure correlation server (correlation server) 1005 forwards programming having targeted advertisements to a network operator 1013. The programming having targeted advertisements may then be forwarded to a user/consumer 1017 via an access network 1015. On the user end, the information may be delivered to a personal computer or a television or any other display means.

FIG. 10 illustrates the ability of a system in accordance with the principles of the present invention to target national advertisements as well as local advertisements. The advertisers may provide national advertisements to a Secure Correlation Server™ 1005 that may match the advertisements to different users 1017. It is to be noted that user 1017 may refer to a single user or a group of users.

The system of FIG. 10 is secure for many reasons. First, the secure correlation server 1005 does not contain raw data such as viewing or purchase records. Second, the correlation server 1005 does not transmit user/consumer information to third parties, and only performs internal calculations to determine the applicability of an advertisement to an individual user or a group of users.

It is to be noted that even though previously described embodiments are described with reference to Internet and television environments, the principles of the present invention are not based on a particular media. The principles of the present invention may be applied to diverse media such as printed media in which there are national (broadcast) advertisements as well as local advertisements, Internet advertisements, radio advertisements (in particular Internet radio broadcasting) and a variety of other forms of media advertisements.

The principles of the present invention also provide novel ways of collecting user information, e.g., users have options to control the flow of information. In one implementation, the users decide whether they want to be enrolled in the profiling, i.e., whether they want their viewing habits and other information to be collected.

In this implementation, the data is collected with the explicit permission of the user, who enrolls in the service and agrees to be profiled, similar to an “opt-in” feature. In the “opt-in” feature, the user is specifically inquired whether he or she wants to be profiled. In exchange for opt-in, the users may receive economic benefit from the service through discounts on cable service, discounts through retail outlets, rebates from specific manufacturers, and other incentive plans.

In the case of video services, the user may be presented with a series of enrollment screens that confirm the user's opt-in and ask the user for specific demographic information that may be used to create one or more user profile vectors.

In performing the enrollment process, it is possible to obtain specific demographic information including household income, size, and age distribution. Although this information is not necessary for profiling, obtaining it from the user allows deterministic information to be used in conjunction with the probabilistic information.

Other opt-in methods may be used for the different media. In an Internet environment, a free browser add-on/plug-in may be used that performs profiling through one or more secured techniques that remove cookies, alters/hides surf streams. In this case, the user will have an option to enroll in a secure system that permits profiling in a controlled and secure manner along with providing economic incentives for participation in the profiling process. Upon enrolling in the service, a profiling module may be downloaded or activated that may perform the profiling through the browser. The present invention allows manufacturers and advertisers to use their advertising dollars more effectively across a multitude of media platforms including video and Internet domains, and eventually extending into the printed media.

The system is based on the premise that the users may agree to have advertisements delivered to them on a more selective basis than the prior art “linked sponsorship” model in which advertisements are only linked to the contents of the programming. Users who sign up for this service will receive discounts from the Internet access or video service provider. Advertisers may send profile vectors for their advertisements to a Secure Correlation Server™ (SCS) which allows the advertisement to be correlated to the user profile vectors. No information regarding the user is released, and users who do not wish to participate in the service are not profiled.

The general principles of the present invention are not constrained to television networks and may be generally applied to a variety of media systems including printed media, radio broadcasting, and store coupons. The system provides the overall capability to increase effectiveness of the advertisements by using profile vectors that do not contain the raw transaction information.

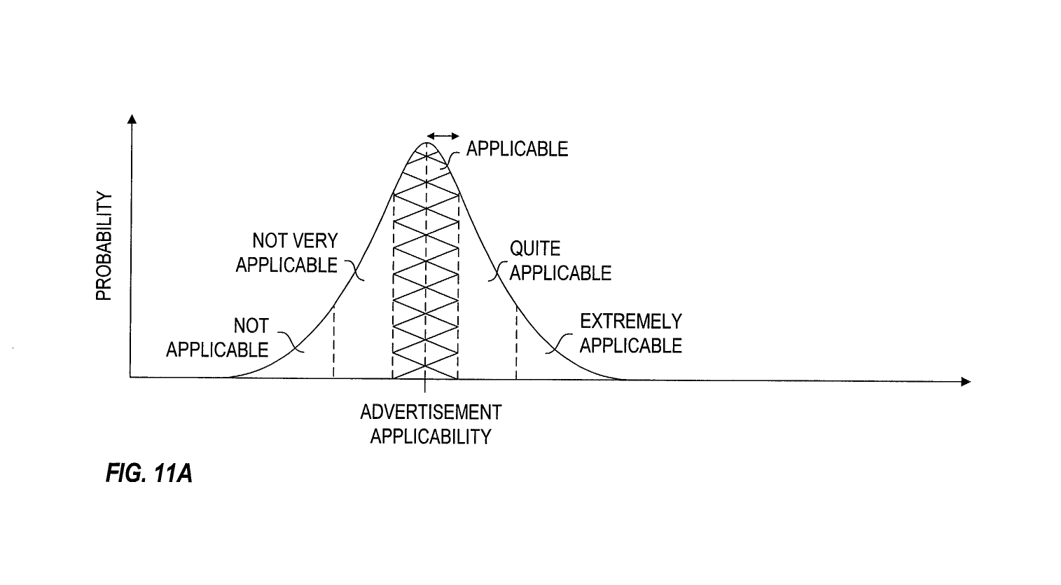

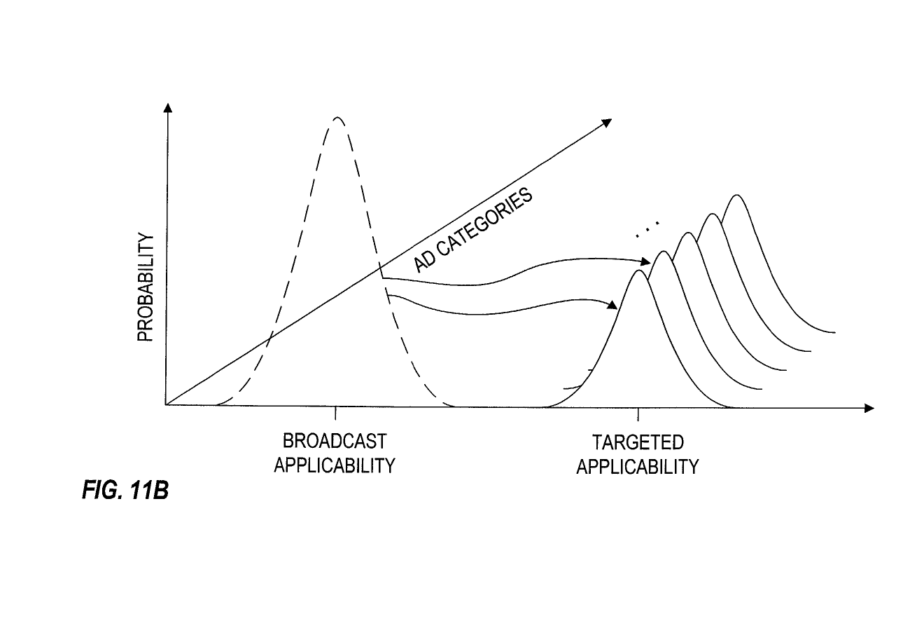

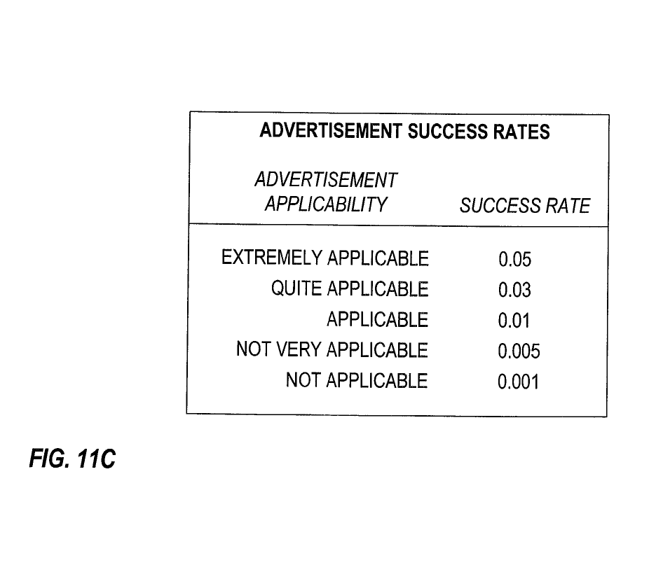

Thus, the principles of the present invention propose a method and system for targeting advertisements to only a selected number of users or to a selected group of users without jeopardizing the privacy of the users. As illustrated in FIG. 11A, advertisement applicability, in accordance with the principles of the present invention, may be modeled as a distribution curve. As illustrated in FIG. 11A, a well-designed advertisement may be found to be “applicable” by the majority of users, but there will be a number of users for whom the advertisement will not be applicable. Similarly, some of the users may find the advertisement to be quite applicable or extremely applicable. The users that find the advertisement to be extremely applicable are most likely to purchase the product or service, and the users that find the advertisement to be less applicable are less likely to purchase the product or service.

Thus, in accordance with the principles of the present invention, the overall potential may be divided into subgroups (smaller groups), and the advertisement may be displayed only to the subgroup that is most interested in the advertisement and is most likely to purchase the product. FIG. 11B illustrates an exemplary case where users are divided into subgroups, and the advertisement is displayed only to a subgroup of the users.

By forming subgroups and targeting advertisements to one or more subgroups, the effectiveness of the advertisements may be greatly increased, and overall advertisement success rates may be increased. The increase in overall advertisement success rates represents more effective use of advertising dollars, and is a “welfare gain” in the sense that those dollars may be used for other goods and services. FIG. 11C illustrates an exemplary case where different success rates are determined by measuring products or services that were purchased as the result of the viewing of an advertisement. As can be seen, the highest success rate corresponds to the subgroup that finds the advertisement to be extremely applicable, and the lowest success rate corresponds to the subgroup that finds the advertisement least applicable

Having thus described a few particular embodiments of the invention, various alterations, modifications, and improvements will readily occur to those of ordinary skill in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A computer-implemented method for presenting one or more targeted advertisements to a user, the method comprising:
monitoring user behavior for one or more intentional actions to collect transaction related data; and
processing the transaction related data to generate one or more profile vectors.

2. The method of claim 1, wherein each transaction is identified by unique transaction identifications.

3. The method of claim 2, wherein the transaction identification is based on an arbitrary number selected randomly to preserve user privacy.

4. The method of claim 1, wherein the user is identified by a unique profile identification.

5. The method of claim 4, wherein the profile identification is based on an arbitrary number selected randomly to preserve user privacy.

6. The method of claim 1, wherein the profile vector includes one or more demographic attributes about the user.

7. The method of claim 6, wherein the demographic attributes represent a probability that a user falls within a certain demographic category, such as an age group, gender, household size, or income range.

8. The method of claim 6, wherein the demographic attributes further include one or more interest categories organized according to broad areas.

9. The method of claim 1, wherein the profile vector represents one or more product preference categories of the user.

10. The method of claim 9, wherein the product preference categories are organized according to broad areas, such as music, travel and restaurants.

11. The method of claim 1, wherein the profile vector contains non-deterministic information about the user.

12. The method of claim 1, wherein the profile vector is generated locally to a user interface.

13. The method of claim 1, wherein the transaction refers to a television viewing session.

14. The method of claim 13, wherein the profile vector is locally generated in a set-top box.

15. The method of claim 14, wherein the profile vector refers back a MAC_ID of the set-top box.

16. The method of claim 14, wherein the set-top box comprises a memory for storing one or more profile vectors.

17. The method of claim 13, wherein a head-end receives and processes a plurality of the locally generated profile vectors.

18. The method of claim 1, further comprising aggregating a plurality of profile vectors to compute an aggregated profile vector.

19. The method of claim 18, wherein the aggregated profile vector is updated each time a new transaction corresponding to a particular user occurs.

20. The method of claim 18, wherein the aggregated profile vector is computed within a set-top box.

21. The method of claim 18, wherein a head-end receives and processes a plurality of aggregated profile vectors.

22. The method of claim 1, further includes utilizing the profile vector to find a target advertisement to be presented to the user.

23. The method of claim 1, further comprising forwarding the profile vector to a secure correlation server.

24. The method of claim 23, further includes matching one or more targeted advertisements to be presented to the user based on the contents of the profile vector.

25. The method of claim 24, wherein the matching is performed by the secure correlation server.

26. The method of claim 1, wherein the transaction related data includes Internet surfing data.

27. The method of claim 1, wherein the transaction related data includes purchase transaction data.

28. The method of claim 1, wherein the profile vectors are generated based on one or more heuristic rules.

29. The method of claim 28, wherein the heuristic rules are expressed as conditional probabilities.

30. A computer system for presenting one or more targeted advertisements to one or more users in a privacy protected manner, the system comprising:
a plurality of remote databases storing transactional information relating to one or more user transactions;
a plurality of local profilers coupled to the remote databases for processing the transactional information and generating one or more profile vectors; and
a secure profiling server coupled to the local profilers wherein the secure profiling server receives and processes one or more locally generated profile vectors.

31. The system of claim 30, wherein the secure profiling server computes an aggregated profile vector based on the locally generated profile vectors.

32. The system of claim 30, wherein the remote database stores Internet-related transactional data.

33. The system of claim 32, wherein the remote database stores point-of-sale data.

34. The system of claim 32, wherein the remote database stores Internet surfing data.

35. The system of claim 32, wherein the secure profiling server communicates to a secure correlation server.

36. The system of claim 35, wherein the secure correlation server based on the information from the secure profiling server selects one or more targeted advertisements to be presented to the user.
